(19) United States
(12) Patent Application Publication
(10) Pub. No.: US 2010/0163355 A1
(43) Pub. Date: Jul. 1, 2010

(54) SHOCK ABSORBER

(76) Inventor: Hiroyuki YAMAGUCHI, Ayase-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/644,482

(22) Filed: Dec. 22, 2009

(30) Foreign Application Priority Data
Dec. 25, 2008 (JP) 330920/2008

(51) Int. Cl. F16F 9/50; F16F 9/34

(52) U.S. Cl. 188/280; 188/275

(57) ABSTRACT

A valve main body where an opening of a passage is formed comprises a clamp seat portion adapted to clamp a disk valve, the opening, a non-annular first seat portion where the disk valve can be seated, and an annular second seat portion, which are formed in this order from the inner circumferential side. The first seat portion has an axial height equal to or higher than the axial height of the clamp seat portion and lower than the axial height of the second seat portion.

### BACKGROUND OF THE INVENTION

The present invention relates to a shock absorber.

Some shock absorbers control a damping force with use of the disk valve disposed at the passage through which a fluid flow is generated by a sliding movement of the piston in the cylinder. As such a shock absorber, many types have been developed. For example, Japanese Patent Application Public Disclosure Hei 2-66333 discloses a shock absorber comprising an annular seat and an irregular-shaped (non-annular) seat formed at a seat where a disk valve is seated.

To the damping force characteristic of a shock absorber, there are various kinds of requests according to customer' s needs. Responding to such a request by, for example, changing the seat shape for each request requires preparation of many kinds of valve main bodies where a seat is formed, resulting in increases in the manufacturing cost and the management cost.

### SUMMARY OF THE INVENTION

Therefore, an object of the present invention is to provide a shock absorber in which it is possible to reduce the manufacturing cost and the management cost while obtaining a desired damping characteristic.

To achieve the forgoing and other objects, the present invention provides a shock absorber comprising a valve main body where an opening of a passage is formed, the valve main body comprising a clamp seat portion adapted to clamp a disk valve, the opening, a non-annular first seat portion where the disk valve can be seated, and an annular second seat portion which are formed in this order from the inner circumferential side, the first seat portion having an axial height equal to or higher than the axial height of the clamp seat portion and lower than the axial height of the second seat portion.

### BRIEF DESCRIPTION OF THE DRAWINGS

FIG. 1 is a cross-sectional view of a shock absorber according to an embodiment of the present invention;

FIGS. 2(a), (b), and (c) illustrate a piston for use in the shock absorber according to the embodiment of the present invention, and in particular, FIG. 2(a) is a top view, FIG. 2(b) is a vertical cross-sectional view, and FIG. 2(c) is a bottom view;

FIG. 3 is a vertical cross-sectional view illustrating the piston with first disk valves attached thereto in the shock absorber according to the embodiment of the present invention;

FIG. 4 is a vertical cross-sectional view illustrating the piston with second disk valves attached thereto in the shock absorber according to the embodiment of the present invention;

FIG. 5 is a vertical cross-sectional view illustrating the piston with the first disk valves and the second disk valves attached thereto in the shock absorber according to the embodiment of the present invention;

FIG. 6 is a graph indicating the damping force characteristic of the shock absorber according to the embodiment of the present invention; and

FIG. 7 is a top view illustrating a piston for use in a shock absorber according to another embodiment of the present invention.

### DETAILED DESCRIPTION OF THE PREFERRED EMBODIMENTS

A shock absorber according to an embodiment of the present invention will be described below with reference to the accompanying drawings.

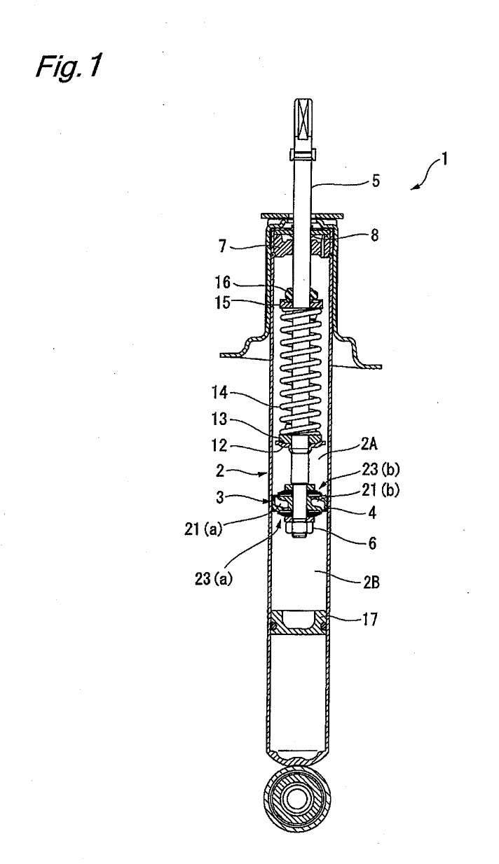

Referring to FIG. 1, a shock absorber 1 according to the present embodiment includes a bottomed cylindrical cylinder 2. A piston (valve main body) 3 is slidably fitted in the cylinder 2. The inside of the cylinder 2 is divided into two chambers, a cylinder upper chamber 2A and a cylinder lower chamber 2B by the piston 3 and an annular sliding member 4 attached to the outer circumferential surface of the piston 3. One end of a piston rod 5 is coupled to the piston 3 by a nut 6, and the other end of the piston rod 5 extends to the outside through a rod guide 7 and an oil seal 8 attached to the opening of the cylinder 2.

A retainer 12, a spring bearing 13, a coil spring 14, a spring bearing 15, and a shock absorbing body 16 are disposed around or on the piston rod 5 in this order from the piston 3 to the rod guide 7. The piston rod 5 is inserted through the retainer 12, the spring bearing 13, the coil spring 14, the spring bearing 15, and the shock absorbing body 16. The retainer 12 is fixed to the piston rod 5, whereby one end of the coil spring 14 is engaged with the piston rod 5 via the spring bearing 13. On the other hand, the spring bearing 15 and the shock absorbing body 16 are slidable relative to the piston rod 5 by the extension and compression of the coil spring 14. Referring to the bottom side of the cylinder 2 lower than the piston 3, a defining body 17 is slidably disposed in the cylinder 2 for defining the cylinder lower chamber 2B between the piston 3 and the defining body 17. a hydraulic fluid is sealingly contained in the cylinder upper chamber 2A and the cylinder lower chamber 2B in the cylinder 2.

The piston 3 is made of a sintered metal. The piston 3 includes a plurality of passages 21 through which the cylinder upper chamber 2A and the cylinder lower chamber 2B are in communication with each other. A sliding movement of the piston 3A causes the hydraulic fluid to pass through the passages 21, thereby generating the flow of the hydraulic fluid.

The plurality of passages 21 comprises extension-side passages 21(a) and compression-side passages 21(b).

The extension-side passages 21(a) are constituted by half of the plurality of passages 21. This half of the passages 21, and the other half of the passages 21 constituting the compression-side passages 21(b) are alternately arranged at the piston 3. The extension-side passages 21(a) each include an extension-side upper opening (the other end opening 38 which will be described later) which is open to the upper side in FIG. 1, and an extension-side lower opening (one end opening 37 which will be described later) which is open to the lower side in FIG. 1. The extension-side upper opening is formed at the radially outer side at one axial side (upper side in FIG. 1) of the piston 3. The extension-side lower opening is open at the radially inner side at the other axial side (lower side in FIG. 1) of the piston 3. A common damping force generating mechanism 23 is disposed for the extension-side passages 21(a) constituted by the half of the passages 21. When the piston 3 moves to the extension side so that the piston rod 5 further protrudes outside the cylinder 2, the hydraulic fluid passes through the extension-side passages 21(a). The damping force generating mechanism 23 disposed for the extension-side passages 21(a) constitutes an extension-side damping force generating mechanism 23(a) configured to generate a damping force by controlling the flow of a hydraulic fluid through the extension-side passages 21(a).

The compression-side passages 21(b) are constituted by the other half of the passages 21 which are alternately disposed at the piston 3. The compression-side passages 21(b) each include a compression-side lower opening (the other end opening 38 which will be described later) which is open to the lower side in FIG. 1, and a compression-side upper opening (one end opening 37 which will be described later) which is open to the upper side in FIG. 1. The compression-side lower opening is formed at the radially outer side at the other axial side (lower side in FIG. 1) of the piston 3. The compression-side upper opening is formed at the radially inner side at the one axial side (upper side in FIG. 1) of the piston 3. A common damping force generating mechanism 23 is disposed for the compression-side passages 21(b) constituted by the other half of the passages 21. When the piston 3 moves to the compression side so that the piston rod 5 further enters the cylinder 2, the hydraulic fluid passes through the compression-side passages 21(b). The damping force generating mechanism 23 disposed for the compression-side passages 21(b) constitutes a compression-side damping force generating mechanism 23(b) configured to generate a damping force by controlling the flow of a hydraulic fluid through the compression-side passages 21(b).

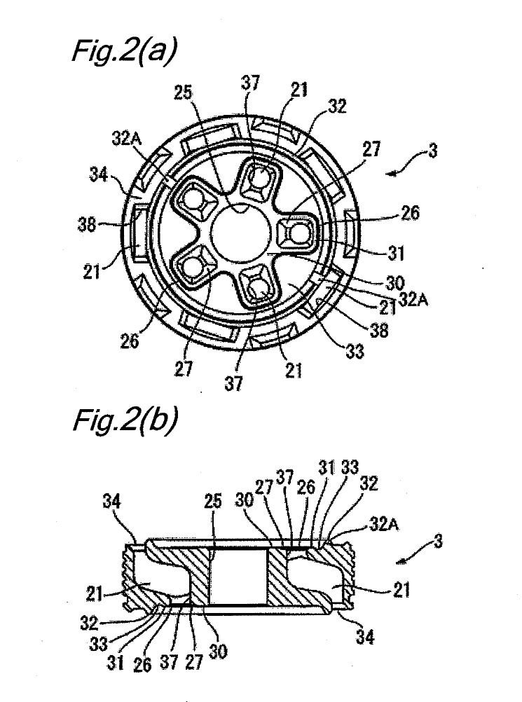

As shown in FIG. 2, the piston 3 has a substantially disk shape. The center of the piston 3 is axially penetrated so as to form an insertion hole 25 through which the piston rod 5 is inserted. The piston 3 shows the same shape and configuration even if it is flipped in the axial direction, i.e., its front and back are reversed.

Both the axial sides of the piston 3 each include a plurality of extension portions 26 (five extension portions 26 in the present embodiment) having a same axial height. The extension portions 26 extend in a radial manner around the insertion hole 25. The extension portions 26 at the respective axial sides are out of phase with each other so that the extension portions 26 at the other axial side are situated between the adjacent extension portions 26 at the one axial side. The ends of the extension portions 26 near the insertion hole 25 are connected with the ends of their circumferentially adjacent extension portions 26 at the same axial side. All of the extension portions 26 include axially concaved recesses 27 formed only at the centers thereof.

Both the axial sides of the piston 3 each include an annular clamp seat portion 30 formed around the insertion hole 25. The clamp seat portion 30 has a same axial height, and extends circumferentially continuously.

Further, both the axial sides of the piston 3 each include a first seat portion 31. The first seat portion 31 is defined by connecting the outer circumferential edges of all of the extension portions 26 at the same axial side, and therefore has a same axial height and an irregular enclosing (not annular) shape. The clamp seat portion 30 and the first seat portion 31 at the same axial side share a common contiguous side, and are disposed on a same plane perpendicular to the axis of the piston 3.

Both the axial sides of the piston 3 each include an annular second seat portion 32. The second seat portion 32 is formed so as to surround all of the extension portions 26 at the same axial side from the radially outer sides thereof. The second seat portion 32 has a higher axial height than those of the clamp seat portion 30 and the first seat portion 31 at the same axial side. A low portion 33 is formed between the first seat portion 31 and the second seat portion 32 at the same axial side so as to have a slightly lower axial height than that of the first seat portion 31. A stepped portion 34 is formed around the second seat portion 32 so as to have a lower axial height than that of the second seat portion 32. One or more recesses are formed at the seat surface of the second seat portion 32 so as to define fixed orifice(s) 32A.

One end openings (opening) 37 of the passages 21 axially penetrating through the piston 3 are open at all of the above-mentioned recesses 27. All of the passages 21 are formed such that the other end openings (opening) 38 of the passages 21 are open at the stepped portion 34 at the axially opposite side in phase with the one end openings 37. The one end openings 37 each have a circular shape, and the other end openings 38 each have a rectangular shape elongated in the circumferential direction of the piston 3.

As seen from the above description, the clamp seat portion 30, the one end openings 37, the non-annular first seat portion 31, and the annular second seat portion 32 are formed, in this order from the radially inner side, at each of the axial sides of the piston 3. The axial height of the first seat portion 31 is the same as that of the clamp seat portion 30 at the same axial side, and is lower than that of the second seat portion 32 at the same axial side.

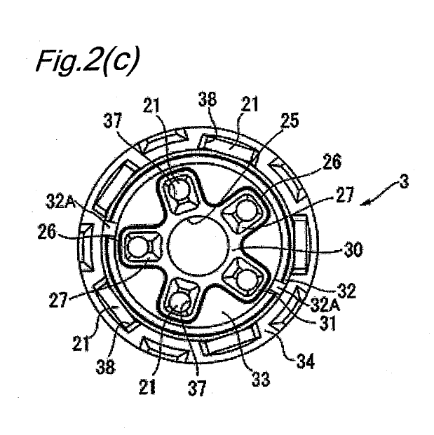

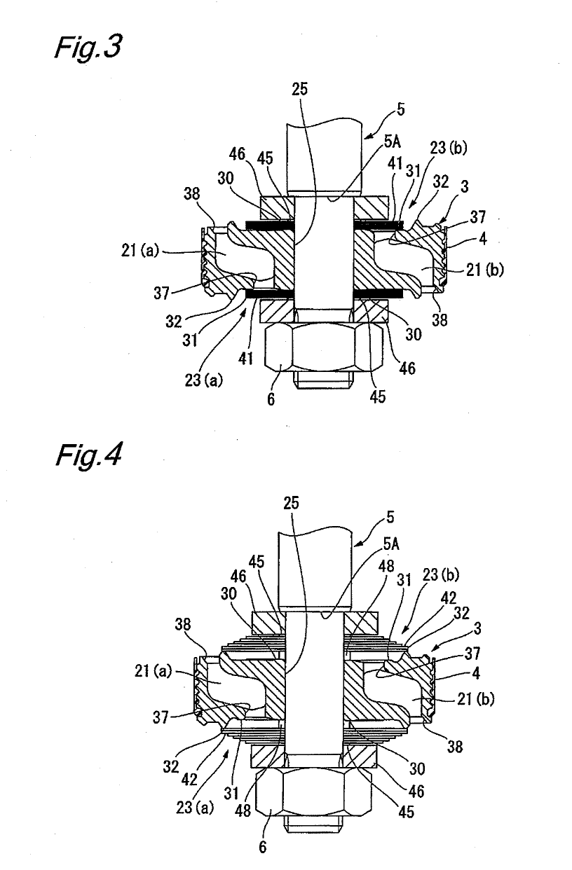

For the damping force generating mechanism 23, an annular first disk valve (disk valve) 41 shown in FIG. 3 and an annular second disk valve (disk valve) 42 shown in FIG. 4 are prepared. The first disk valve 41 has a smaller diameter than that of the second seat portion 32, and can be seated over the entire first seat portion 31. The second disk valve 42 has a larger diameter than that of the first disk valve 41, and can be seated over the entire second seat portion 32.

For the attachment of the first disk valve 41, the following process is performed at the respective axial sides of the piston 3, as shown in FIG. 3.

First, the first disk valve 41 is placed so that the center side of the first disk valve 41 abuts against the clamp seat portion 30 and the radially outer side of the first disk valve 41 abuts against the first seat portion 31.

Then, a spacer 45, which is made of a thin annular plate having a smaller diameter than that of the first disk valve 41, is placed at the axially outer side of each of the first disk valves 41.

Further, a thick annular valve retaining member 46 having a larger diameter than that of the spacer 45 is placed at the axially outer side of each of the spacers 45. Then, they are fastened from both the axial sides thereof by the nut 6 and the stepped portion 5A of the piston rod 5.

In this way, the damping force generating mechanism 23 is constructed by attaching the first disk valve 41, which can abut against the first seat portion 31 and has a smaller diameter than that of the second seat portion 32, to the piston 3 so that the first disk valve 41 covers the one end openings 37 of the passages 21. It should be noted that the first disk valve 41 cannot abut against the second seat portion 32, and the other end openings 38 of the passages 21 are constantly in an open state.

During an extension stroke of the piston rod 5, a sliding movement of the piston 3 in the cylinder 2 causes the hydraulic fluid in the cylinder upper chamber 2A to flow into the cylinder lower chamber 2B through the extension-side passages 21(a) of the piston 3. At this time, a damping force is generated due to the flow resistance of the extension-side damping force generating mechanism 23(a) including the first disk valve 41. On the other hand, during a compression stroke of the piston rod 5, a sliding movement of the piston 3 in the cylinder 2 causes the hydraulic fluid in the cylinder lower chamber 2B to flow into the cylinder upper chamber 2A through the compression-side passages 21(b) of the piston 3. A this time, a damping force is generated due to the flow resistance of the compression-side damping force generating mechanism 23(b) including the first disk valve 41.

For the attachment of the second disk valve 42, the following process is performed at the respective axial sides of the piston 3, as shown in FIG. 4.

First, an annular spacer 48 having a small diameter is placed so as to abut against the clamp seat portion 30.

Then, the second disk valve 42 is placed at the axially outer side of each of the spacers 48 so that the center side of the second disk valve 42 abuts against the spacer 48 and the radially outer side of the second disk valve 42 abuts against the second seat portion 32.

Further, the spacer 45, which is made of a thin annular plate having a smaller diameter than that of the second disk valve 42, is placed at the axially outer side of each of the second disk valves 42.

Further, the thick annular valve retaining member 46 having a larger diameter than that the spacer 45 is placed at the axially outer side of each of the spacers 45. Then, they are fastened from both the axial sides thereof by the nut 6 and the stepped portion 5A of the piston rod 5.

In this way, the damping force generating mechanism 23 is constructed by attaching the second disk valve 42, which has a larger diameter than that of the first seat portion 31 and can abut against the second seat portion 32, to the piston 3 so that the second disk valve 42 covers the one end openings 37 of the passages 21. It should be noted that the second disk valve 42 cannot abut against the first seat portion 31, and the other end openings 38 of the passages 21 are constantly in an open state.

Further, both the first disk valve 41 and the second disk valve 42 can be attached to the piston 3 at the same time.

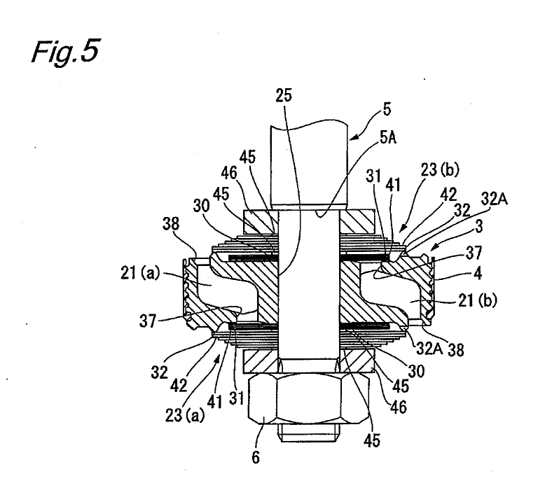

For the attachment of both the first disk valve 41 and the second disk valve 42, the following process is performed at the respective axial sides of the piston 3, as shown in FIG. 5.

First, the first disk valve 41 is placed so that the center side of the first disk valve 41 abuts against the clamp seat portion 30 and the radially outer side of the first disk valve 41 abuts against the first seat portion 31.

Then, the spacer 45, which is made of a thin annular plate having a smaller diameter than that of the first disk valve 41, is placed at the axially outer side of each of the first disk valves 41.

Further, the second disk valve 42 is placed at the axially outer side of each of the spacers 45 so that the center side of the second disk valve 42 abuts against the spacer 45 and the radially outer side of the second disk valve 42 abuts against the second seat portion 32.

Further, the spacer 45, which is made of a thin annular plate having a smaller diameter than that of the second disk valve 42, is placed at the axially outer side of each of the second disk valves 42.

Further, the thick annular valve retaining member 46 having a larger diameter than that of the spacer 45 is placed at the axially outer side of each of the spacers 45. Then, they are fastened from both the axial sides thereof by the nut 6 and the stepped portion 5A of the piston rod 5.

In this way, the first disk valve 41, which can abut against the first seat portion 31 and has a smaller diameter than that of the second seat portion 32, and the second disk valve 42, which has a larger diameter than that of the first seat portion 31 and can abut against the second seat portion 32, are attached to the piston 3 at the same time so that the disk valves 41 and 42 cover the one end openings 37 of the passages 21. It should be noted that, in this case, the other end openings 38 of the passages 21 are also constantly in an open state.

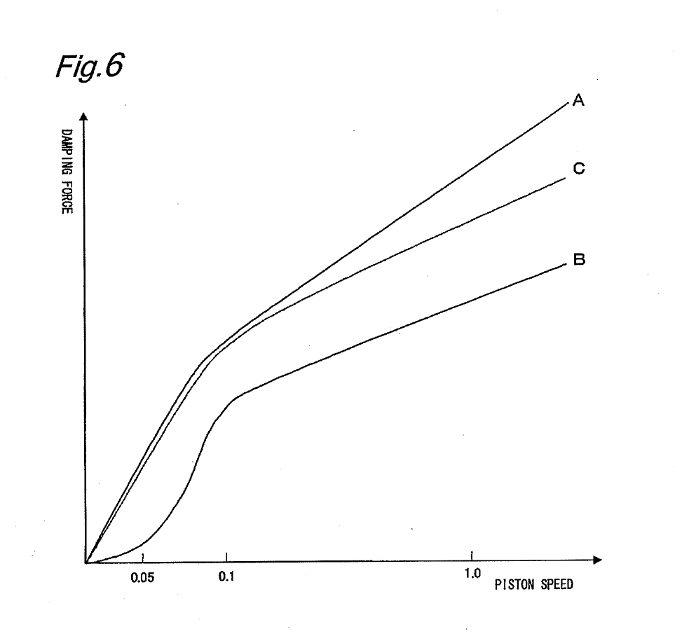

Referring to FIG. 6, the line A represents the damping force characteristic with respect to the piston speed when the first disk valve 41 is used alone as shown in FIG. 3.

During the extremely low speed period (0 to 0.05 m/s), since the first disk valve 41 is moved away from the extension portions 26 of the first seat portion 31 so that the hydraulic fluid flows through the partial portions provided at intervals around the circumference of the first disk valve 41, where the first disk valve 41 is spaced apart from the extension portions 26. In other words, the hydraulic fluid does not flow around the entire circumference of the first disk valve 41. This characteristic shows the valve characteristic (first-order characteristic) that provides a relatively large damping coefficient. After that, during the low speed period (around 0.1 m/s), the first disk valve 41 is further moved to be entirely spaced apart from the first seat portion 31, so that a lower damping coefficient than that during the extremely low speed period is obtained.

When the second disk valve 42 is used alone as shown in FIG. 4, the damping force characteristic with respect to the piston speed generates a smaller damping force for the same piston speed, compared to the case using the first disk valve 41 alone, as indicated by the line B in FIG. 6. That is, from the extremely low speed period (0 to 0.05 m/s) to the low speed period (around 0.1 m/s), the orifice characteristic (second-order characteristic) is generated by the fixed orifice 32A, resulting in generation of a small damping force during the extremely low speed period.

From the low speed period to the middle and high speed period, since the second disk valve 42 is moved away from the second seat portion 31 to be opened, the valve characteristic is exercised. It should be noted that, since the second seat portion 32 has a circular shape, the opening area is instantly increased at the moment of opening of the second disk valve 42, resulting in a reduce in the damping coefficient in an almost discontinuous manner.

When both the first disk valve 41 and the second disk valve 42 are used as shown in FIG. 5, the characteristic intermediate between their characteristics is obtained as indicated by the line C in FIG. 6. That is, three kinds of damping force characteristics can be obtained by using the same single piston 3.

According to this characteristic, during the extremely low speed period (0 to 0.05 m/s), the first disk valve 41 is moved away from the extension portions 26 of the first seat portion 31 to be spaced apart therefrom. Therefore, the hydraulic fluid flows through the partial portions provided at intervals around the circumference of the first disk valve 41, where the first disk valve 41 is spaced apart from the extension portions 26 (in other words, the hydraulic fluid does not flow around the entire circumference of the first disk valve 41), so that the valve characteristic (first-order characteristic) that provides a relatively large damping coefficient is exercised. After that, during the low speed period (around 0.1 m/s), the opening area of the first disk valve 41 becomes nearly equal to the opening area of the fixed orifice 32A, and the orifice characteristic of the fixed orifice 32A is exercised. Immediately after that, the second disk valve 42 is moved away from the circular second seat portion 32 to be spaced apart from. At this time, unlike the case shown in FIG. 4, since the characteristic of the first disk valve 41 is added, an instant increase in the opening area does not occur at the moment of opening of the second disk valve 42, so that the damping coefficient is continuously and smoothly reduced during the low speed period. Therefore, due to the combination of the irregular-shaped first seat portion 31 and the first disk valve 41, the circular second seat portion 32 and the second disk valve 42, and the fixed orifice 32A, it is possible to obtain the valve characteristic that provides a large damping coefficient during the extremely low speed period, a smooth change in the damping coefficient during the low speed period, and a desired damping characteristic with the aid of the second disk valve 42 during the middle and high speed period.

According to the shock absorber 1 of the present embodiment discussed above, the clamp seat portion 30 configured to clamp at least one of the disk valves 41 and 42, the one end openings 37, the non-annular first seat portion 31 where the disk valve 41 can be seated, and the annular second seat portion 32 where the disk valve 42 can be seated are formed in this order from the inner circumferential side at the piston 3 where the one end openings 37 of the passages 21 are formed. Since the axial height of the first seat portion 31 is equal to that of the clamp seat portion 30 and lower than that of the second seat portion 32, as mentioned above, the piston 3 can be commonly used for obtaining three kinds of damping force characteristics, i.e., the characteristic when only the first disk valve 41 is attached, the characteristic when only the second disk valve 42 is attached, and the characteristic when both the disk valves 41 and 42 are attached. Therefore, the manufacturing cost and the management cost can be reduced.

The axial height of the first seat portion 31 may be higher than that of the clamp seat portion 30. In this case, the first seat portion and the clamp seat portion may be spaced apart, and a spacer may be disposed at the clamp seat portion. Alternatively, the first seat portion and the clamp seat portion may share a common contiguous side similarly to the present embodiment, and the first seat portion may have a tapered shape having a higher axial height at the radially outer side than that at the radially inner side.

According to the structure shown in FIG. 3, in which the first disk valve 41 adapted to abut against the first seat portion 31 has an outer diameter smaller than that of the second seat portion 32 so that the first disk valve 41 does not abut against the second seat portion 32, it is possible to generate the damping force characteristic by the first seat portion 31 in the low speed region. In this case, it is possible to add a characteristic similar to the characteristic by the second seat portion 32 in the low speed region, by adding an orifice having a small fixed area to the first seat portion 31.

According to the structure shown in FIG. 4, in which the second disk valve 42 adapted to abut against the second seat portion 32 has an outer diameter larger than that of the first seat portion 31 so that the second disk valve 41 does not abut against the first seat portion 31, it is possible to generate the damping force characteristic by the second seat portion 32 in the low speed region.

According to the structure shown in FIG. 5, in which the first disk valve 41 adapted to abut against the first seat portion 31 has an outer diameter smaller than that of the second seat portion 32, and the second disk valve 42 adapted to abut against the second seat portion 32 has an outer diameter larger than that of the first seat portion 31, it is possible to adjust the damping force characteristic in the low speed region by the first seat portion 31 and the first disk valve 41, and adjust the damping force characteristic in the middle speed region by the second seat portion 32 and the second disk valve 42, whereby it is possible to improve flexibility in adjustment of the damping force in the low speed region and the middle speed region.

In the above mentioned embodiment, the present invention is employed at the piston 3, although it may be employed at a positionally fixed base valve as a separate body from the piston 3, or it may be employed at both the piston 3 and the base valve. Further, the present invention may be employed at one of the extension-side and compression-side of the piston 3. Further, a communication passage connecting the cylinder upper chamber and the lower chamber may be provided outside the cylinder, and the above-mentioned damping force generating mechanism may be disposed at this communication passage.

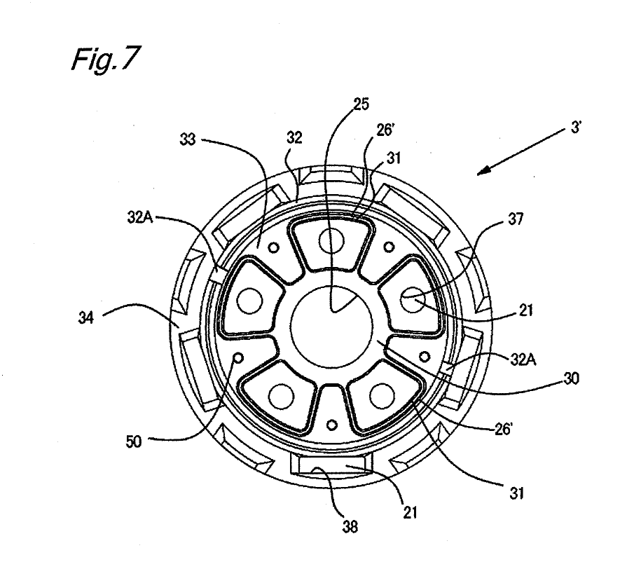

Another embodiment of the present invention will now be described with reference to FIG. 7. In the following description, like components will be denoted by like reference numerals as in the above-mentioned embodiment, and only different points will be described in detail. FIG. 7 is a top view of a piston for use in a shock absorber according to the another embodiment of the present invention.

A piston 3′ in the another embodiment is different from the piston 3 in the above-mentioned embodiment in terms of the shape of extension portions 26′ formed at both the axial sides of the piston 3′. More specifically, in the extension portions 26 in the above-mentioned embodiment, the width of the space surrounded by each of the extension portions 26, which extends around the passage 21 from the insertion hole 25 side to the second seat portion 32 side, does not vary. On the contrary, in the extension portions 26′ in the another embodiment, the width of the space surrounded by each of the extension portions 26′, which extends around the passage 21 from the insertion hole 25 side to the second seat portion 32 side, is increasing toward the second seat portion 32 side. Further, in the another embodiment, the piston 3′ comprises protrusions 50 having the same axial height as that of the first seat portion 31. The protrusions 50 serve as supports for supporting the disk valve when the disk valve is deflected in response to a pressure from the upstream cylinder chamber during the reverse stroke.

Due to this structure, the pressure-receiving area of the first disk valve 41 abutting against the first seat portion 31 is increased, whereby the damping force can be reduced. In addition, due to the increase in the pressure-receiving area, it is possible to achieve a small damping force in the high-speed region.

In the embodiments discussed herein, the fixed orifice 32A is formed at the second seat portion 32 by, for example, the coining method. However, the present invention is not limited to these embodiments, and the fixed orifice may be provided by forming one or more cutouts at the outer circumference of the second disk valve 42 which abuts against the second seat portion 32.

In the embodiments discussed herein, the piston 3 is constituted by a single piece, although its manufacturing situation does not exclude the possibility of the piston 3 constituted by two, three or more pieces.

As mentioned above, according to the shock absorber of the embodiments discussed herein, the piston 3 can be commonly used for obtaining three kinds of damping force characteristics, i.e., the characteristic when only the first disk valve 41 is attached, the characteristic when only the second disk valve 42 is attached, and the characteristic when both the disk valves 41 and 42 are attached. Therefore, the manufacturing cost and the management cost can be reduced, compared to a shock absorber requiring many kinds of valve main bodies where a seat is formed.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2008-330920, filed on Dec. 25, 2008.

The entire disclosure of Japanese Patent Application No. 2008-330920 filed on Dec. 25, 2008 including specification, claims, drawings and summary is incorporated herein by reference in its entirety.

What is claimed is:

1. A shock absorber comprising:
a cylinder sealingly containing fluid;
a piston slidably disposed in the cylinder;
a piston rod coupled to the piston, the piston rod extending from the cylinder to the outside of the cylinder;
a passage through which a fluid flow is generated by a sliding movement of the piston in the cylinder; and
a damping force generating mechanism comprising a disk valve disposed at the passage, and a valve main body comprising an opening of the passage,
the valve main body comprising
a clamp seat portion adapted to clamp the disk valve,
the opening,
a non-annular first seat portion where the disk valve can be seated, and
an annular second seat portion, which are formed in this order from the inner circumferential side,
the first seat portion having an axial height equal to or higher than the axial height of the clamp seat portion and lower than the axial height of the second seat portion.

2. The shock absorber according to claim 1, wherein the valve main body is the piston.

3. The shock absorber according to claim 2, wherein the disk valve adapted to abut against the first seat portion has an outer diameter smaller than the outer diameter of the second seat portion so that the disk valve does not abut against the second seat portion.

4. The shock absorber according to claim 2, wherein the disk valve adapted to abut against the second seat portion has an outer diameter larger than the outer diameter of the first seat portion so that the disk valve does not abut against the first seat portion.

5. The shock absorber according to claim 2, wherein the disk valve adapted to abut against the first seat portion has an outer diameter smaller than the outer diameter of the second seat portion, and the disk valve adapted to abut against the second seat portion has an outer diameter larger than the outer diameter of the first seat portion.

6. The shock absorber according to claim 5, further comprising a fixed orifice for normally allowing communication between the second seat portion and the disk valve.

7. A shock absorber comprising:
a cylinder sealingly containing fluid;
a piston slidably disposed in the cylinder, the piston dividing the inside of the cylinder into a first cylinder chamber and a second cylinder chamber; and
a piston rod coupled to the piston, the piston rod extending from the cylinder to the outside of the cylinder;
wherein the piston comprises a passage through which a fluid flow is generated by a sliding movement of the piston in the cylinder, and the first cylinder chamber and the second cylinder chamber are in communication with each other through the passage;
the shock absorber further comprises a damping force generating mechanism for generating a damping force by applying a resistance to the fluid flowing through the passage;
the damping force generating mechanism comprises a valve seat portion formed at the piston;
an opening of the passage is formed at the valve seat portion;
the valve seat portion comprises a clamp seat portion, the opening, a non-annular first seat portion, and an annular second seat portion, which are formed in this order from the inner circumferential side of the valve seat portion;
the first seat portion has an axial height equal to or higher than the axial height of the clamp seat portion and lower than the axial height of the second seat portion;
the damping force generating mechanism comprises
at least one of an annular first disk valve having a smaller diameter than the diameter of the second seat portion and capable of being seated on the entire first seat portion, and
an annular second disk valve having a larger diameter than the diameter of the first disk valve 41 and capable of being seated on the entire second seat portion 32; and
the clamp seat portion 30 can clamp at least one of the first disk valve 41 and the second disk valve 42 so that the opening can be closed by at least one of the first disk valve 41 and the second disk valve 42.

8. The shock absorber according to claim 7, wherein:
the shock absorber comprise only the first disk valve of the first disk valve and the second disk valve; and
the first disk valve does not abut against the second seat portion, and the opening can be closed by the first disk valve.

9. The shock absorber according to claim 7, wherein:
the shock absorber comprise only the second disk valve of the first disk valve and the second disk valve; and
the second disk valve does not abut against the first seat portion, and the opening can be closed by the second disk valve.

10. The shock absorber according to claim 7, wherein:
the shock absorber comprises the first disk valve and the second disk valve;
the first disk valve does not abut against the second seat portion;
the second disk valve does not abut against the first seat portion; and
the opening can be closed by the first disk valve and the second disk valve.

11. The shock absorber according to claim 7, wherein:
the passage comprises the opening and a second opening;
the opening is provided at one side of the first cylinder chamber and the second cylinder chamber; and
the second opening is provided at the other side of the first cylinder chamber and the second cylinder chamber.

12. The shock absorber according to claim 11, wherein the second opening of the passage is constantly in an open state.

13. The shock absorber according to claim 7, further comprising a fixed orifice for normally allowing communication between the second seat portion and the disk valve.
